(19) United States
(12) Patent Application Publication
(10) Pub. No.: US 2009/0172915 A1
(43) Pub. Date: Jul. 9, 2009

(54) Swivel Wheel Unit and Wheelchair With At Least One Swivel Wheel Unit

(76) Inventor: Kurt Hunziker, Steffisburg (CH)

Correspondence Address: MORRISS OBRYANT COMPAGNI, P.C., 734 EAST 200 SOUTH, SALT LAKE CITY, UT, 84102, US

(21) Appl. No.: 11/887,804

(22) PCT Filed: Mar. 29, 2006
(86) PCT No.: PCT/CH2006/000178

§ 371 Date: Dec. 4, 2008

(30) Foreign Application Priority Data
Mar. 31, 2005 (CH) 580/05

(51) Int. Cl. B60B 33/00

(52) U.S. Cl. 16/46; 16/45

(57) ABSTRACT

The invention relates to a swivel wheel unit comprising a support (11) provided with a vertical pivot (13) which is mounted in a bearing of a wheelchair or another device, such that it can pivot about a pivoting axis (19) when manoeuvring about curves and U-turns, on whose end a swivel wheel (21) is rotationally mounted. A joint (17) displaces about a horizontal axis (23) counter to the force of the spring elements, when the swivel wheel (21) comes into contact with an obstacle (41). Said joint (17) is a spring joint and maintains the pivoting axis (19) in the displayed normal position, as long as no obstacle (41) arises. A lifting wheel (33), which initially raises the swivel wheel (21) in order to overcome the obstacle, is located in front of the swivel wheel (21), but higher, and when the swivel wheel (21) comes into contact with the obstacle (41), the pivoting axis (19) is pivoted and the swivel wheel (21) is lifted further. The arm (38) of the lifting wheel (33) is pivoted therewith, such that the horizontal axis (23) is lifted so that the swivel wheel (21) is lifted again. The swivel wheel (21) can rise above the obstacle (41) as long as the axis (25) of the swivel wheel (21) is higher than the obstacle (41).

The invention relates to a swivel wheel unit with at least one swivel wheel which may be freely pivoted about a vertical pivot axis. With swivel wheel units, the axis of the swivel wheel is arranged at a distance to the vertical pivot axis. Thereby, with forces acting laterally on the swivel wheel, it is essential for a pivot movement to be able to be effected about the vertical pivot axis in an unimpeded manner. The result of this is the fact that the swivel wheel always adjusts itself according to the pursued travel direction, thus follows in the travel direction, which is often expressed by the terms: caster, castor, caster wheel, castoring wheel.

Such swivel wheel units have been used for a series of moving objects for decades, and wheelchairs may also be counted amongst these. Here, when wheelchairs are being discussed, then this is to be understood in a general manner in the context of wheelchairs for handicapped people.

One early example of the use of swivel wheel units is given by U.S. Pat. No. 1,359,145 from the year 1920. Swivel wheel units have also been used for some time with wheelchairs. Thus for example U.S. Pat. Nos. 3,264,658 and 6,712,369 disclose their use as front wheels, U.S. Pat. No. 6,129,165 their use as a rear wheel, and U.S. Pat. No. 5,964,473 their simultaneous use as front wheels and rear wheels. The swivel wheel units used with the cited application examples, as rule, represent standard products which are available on the market, which are mostly simple to assemble. As a rule they comprise a pivot, which may be inserted into a bearing of the travelling object. With other swivel wheel units, the bearing for the pivot belongs to this, and may be fastened for example by way of screws, on the object which is to be provided with such swivel wheel units.

With office stools, the steering wheels have a relatively small diameter. In contrast, with wheelchairs, one desires a larger diameter of swivel wheel, so that one may also overcome obstacles with the wheelchair. The larger the wheel diameter, the easier it is to overcome the obstacle. For reasons of space however, the wheel diameter may not always be dimensioned as would be desirable for overcoming obstacles.

A wheel unit has been suggested in FR 2 345 320, in order to avoid this disadvantage, with which three wheel pairs, of which a first wheel pair makes ground contact, are arranged in a support. A further wheel pair of so-called lifting wheels is arranged in a raised manner, in each case in front of and behind the first wheel pair, and is not in contact with the ground. When an object provided with such wheel units hits an obstacle, then the further wheel pair climbs the obstacle, so that the first wheel pair is lifted and may climb the obstacle. The described wheel unit is not designed as a swivel wheel unit. The mentioned document however is of interest inasmuch as it provides the mathematical basis for the use of a lifting wheel as an aid for overcoming an obstacle.

Whereas with FR 2 345 320, the wheel in contact with the ground is lifted from the ground in a single step, EP 1 323 401 discloses a wheel unit with which, on overcoming an obstacle, up to four lifting wheels arranged one behind the other, lift the wheel having contact with the ground, further and further from the ground, in up to four steps. This wheel unit has a vertical screw bolt, which serves for the fastening by way of a nut on the front axle of a wheelchair. There are no suggestions for the design as a swivel wheel.

Wheelchairs with a middle drive have become popular in recent times. Such wheelchairs have the advantage that they may be used in a restricted space, for example in an elevator. The two middle wheels are rotated in opposite directions, in order to turn in a tight space. Thereby, the front wheels and rear wheels should not inhibit the turning. For this reason, they are designed as swivel wheels, as is disclosed for example in U.S. Pat. No. 6,712,369 and U.S. Pat. No. 5,964,473. For reasons of space however, the front wheels have a relatively small diameter, so that these wheelchairs may only overcome relatively small obstacles if no further measures are provided.

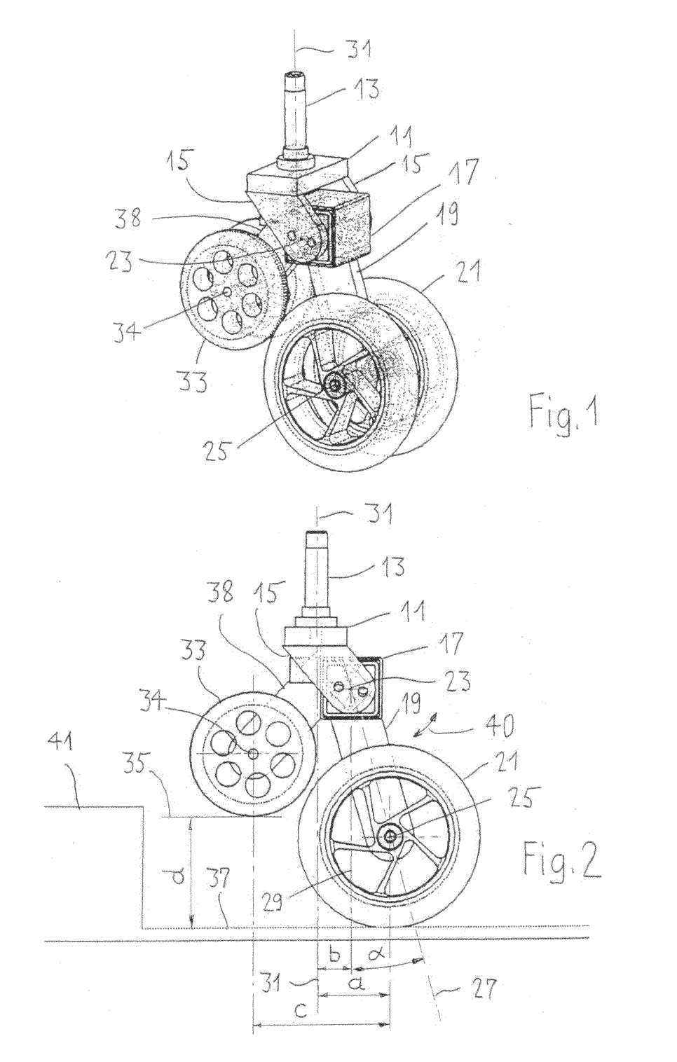

Thus the wheelchair according to U.S. Pat. No. 6,712,369 has a spring mechanism for the rear wheels which permits the front wheels to be lifted. In contrast, with the wheelchair according to FIGS. 1 to 8 of U.S. Pat. No. 5,964,473 (WO 96/15752), one makes use of lifting wheels which are arranged on both sides of the wheelchair at a distance to the front wheel designed as a swivel wheel. Their lifting function however is compromised by the fact that they are assembled in a resilient manner, and thus on hitting an obstacle, are pivoted somewhat upwards before they lift the swivel wheel. As may be further deduced from WO 96/15752 on page 8, lines 8 to 16, the front swivel wheel is arranged in a fork, which may freely rotate about a pivot on a middle support arm, which for its part is fastened on the chassis by way of a spring joint of the type “ROSTA”.

This design with a separate swivel wheel and separate lifting wheels which are fastened on the chassis by way of three support arms and three spring joints, is complicated and expensive and takes up much space, which represents a handicap when using the wheelchair. The described design furthermore has the disadvantage, that on account of the resilient support arms, the lifting wheels are not able to lift the swivel wheel as far as this would be theoretically possible.

The “ROSTA” (™) spring element obtainable on the market is also described in detail at the cited location. This consists of two square tube pieces with different dimensions, wherein the smaller tube piece is rotated by 45 degrees in the inside of the larger tube piece, held by rubber blocks. These permit a limited rotation about the bearing axis, wherein the elasticity of the rubber blocks exerts a spring force, which has the tendency to rotate the inner tube piece back into the initial position. The “ROSTA” spring element is also described with reference to a drawing in CH 681 772.

A wheel suspension for off-road vehicles was suggested in DE 1 952 821 more than thirty years ago, with which two wheels are arranged one behind the other on a balance lever. Four such wheel suspensions are provided with a vehicle, two at the front and two at the back. The front wheel suspensions may be controlled by way of a control wheel, and the rear ones are rigidly fastened on the chassis. With regard to the rear arm of the balance lever (page 5, lines 18 ff, FIG. 6) it is the case that it is preferably connected to an adjustment- and spring device. This device comprises a hydraulic working cylinder, which is connected to a pump with whose help the balance lever may be pivoted, in order to lift or lower the front one of two wheels. The ground freedom is increased by way of the lifting, in order to travel over high vegetation, and a reduced contact pressure of the wheels on the ground may be achieved by way of lowering, which is advantageous when travelling over marshy ground. The spring device is formed by a fluid container which is subdivided by a piston into a fluid- and air chamber. Alternatively, a mechanical spring arrangement is suggested (page 7, lines 23 ff, FIGS. 7 to 9), wherein a torsion rod is applied as a spring element, which runs horizontally below the chassis in the longitudinal direction of the vehicle.

The described wheel suspension is firmly connected to the chassis (FIG. 8) or control device (FIG. 1), thus has no vertical pivot, about whose axis it would be able to swivel as with a swivel wheel unit. Since there is no pivot, as with the previously mentioned FR 2 345 320, it may not be simply assembled by way of inserting a pivot into a bearing of the travelling object, as this is the case with commercially available swivel wheel units as previously described. Added to this is the fact that the adjustment—and spring device must be fastened on the chassis of the vehicle. At all events, it is not possible with a wheelchair, for example to exchange the swivel wheel units with wheel suspensions of the described type. Concluding, one may ascertain that the wheel suspension disclosed more than thirty years ago does not represents a swivel wheel unit (castor wheel) and that this publication, for all those years, evidently provided no hint with regard to the improvement of swivel wheel units, this being despite the fact that a need for this existed, as the previously described state of the art shows.

It is the object of the present invention to avoid the disadvantages of the described designs. In particular, a swivel wheel unit is to be created, with which for example known swivel wheel units of wheelchairs may be replaced, and which also permits relatively large obstacles to be overcome.

According to the present invention, a swivel wheel unit with a swivel wheel which may be pivoted about a vertical pivot axis, and the axis of the swivel wheel is arranged at a horizontal distance to the vertical pivot axis, is characterised in that a lifting wheel is arranged in front of the swivel wheel and that the swivel wheel together with the lifting wheel may be pivoted against the force of spring means about a horizontal axis.

One advantage of this swivel wheel unit lies in the fact that it is a compact construction unit which not only permits the horizontal pivoting of the swivel wheel, for example on turning a wheelchair, but also effects a lifting of the swivel wheel on running up an obstacle, in order to simplify the overcoming of the obstacle, and at the same time to dampen knocks. Added to this is the fact that thereby, the swivel wheel is lifted even more than is the case with the previously described use for lifting wheels, since the horizontal axis is pivoted upwards about the contact point of the lifting wheel with the ground. This is described hereinafter with reference to the drawing. With a wheelchair, the swivel wheels may be dimensioned small, so that more free space remains for the feet.

The horizontal axis is advantageously located practically perpendicularly, or, depending on the spatial conditions present, only slightly displaced above the axis of the swivel wheel. This has the advantage that forces which for example are exerted onto the swivel wheel unit due to the weight of the wheelchair user, create no or a relatively low force component, which tends to act against the force of the spring. In order to keep the force component which thereby counteracts the force of the spring means, small, the angle of the plane in which the rotation axis of the joint and of the swivel wheel lie, is therefore as small as possible, preferably 0 to 15 degrees. However this angle may also be selected somewhat larger, roughly up to 30 degrees, should the spatial conditions require this.

Advantageously, the horizontal axis of the joint is arranged at a distance to the pivot axis of the pin. This allows the construction height of the swivel wheel unit to be kept small, but despite this allows the axis of the swivel wheel to be arranged at a sufficient distance to the vertical pivot axis of the pin, in order to permit a simple pivoting according to the change in travel direction.

Usefully, the vertical pin is arranged on a support, and the joint is formed on the support or is arranged in this. This permits a compact construction manner of the swivel wheel unit with a small construction height. One advantageous design envisages the support comprising two arms, and the joint being arranged between these arms. Usefully, an abutment is provided, which limits the extent of a range of the angular position of the arms when overcoming an obstacle. A limitation of the pivoting, when required, may be effected in the one or the other direction. Various types of spring may be used as a spring means, for example also helical screw springs as in the state of the art, or torsion springs. It has however been found to be advantageous, to design the joint as a spring joint. This may for example be of the type “ROSTA” (™), as has already been described in the introduction. This permits a particularly compact construction manner.

The distance of the running plane of the lifting wheel and of the swivel wheel is usefully equally large or somewhat larger than the radius of the swivel wheel. It is ensured by way of this, that on overcoming a relatively high obstacle, the swivel wheel is lifted so far, that this obstacle may be easily overcome.

It is advantageous in many cases to provide a swivel wheel pair in place of a swivel wheel, and/or a lifting wheel pair instead of a lifting wheel. The overcoming of obstacles is simplified even more by way of this.

The invention also relates to a wheelchair, in particular to a motor-driven wheelchair, with at least one swivel wheel unit according to one of the claims 1 to 13, as a front wheel and/or as a rear wheel.

A few embodiment examples of the invention are described with reference to the drawings.

There are shown in:

FIG. 1 a perspective view of a first embodiment example of the swivel wheel unit,

FIG. 2 a lateral view of the swivel wheel unit of FIG. 1 and the obstacle to be overcome,

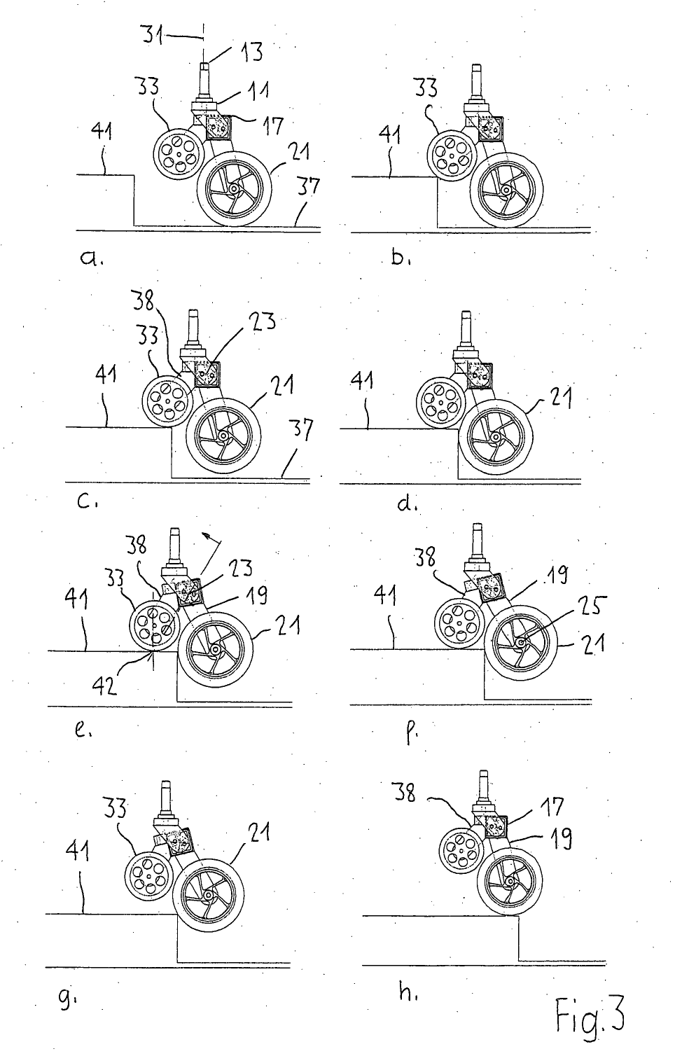

FIG. 3a to 3h various phases on overcoming an obstacle,

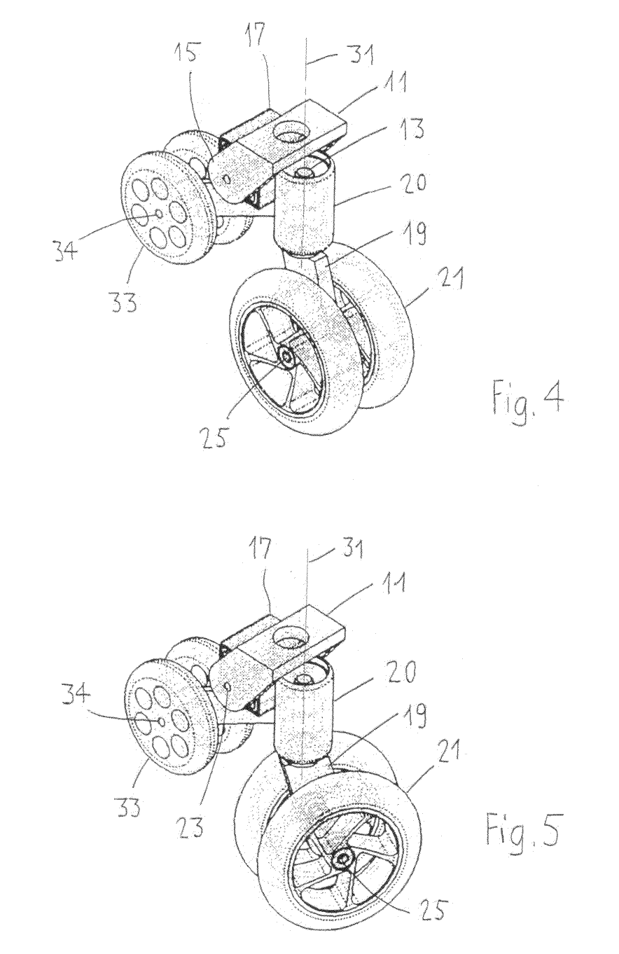

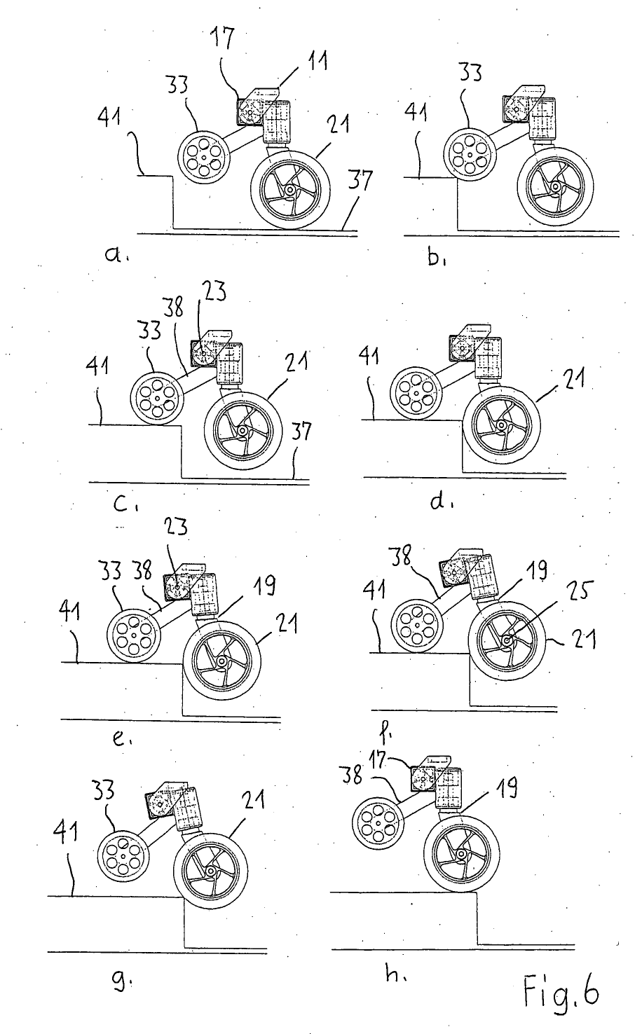

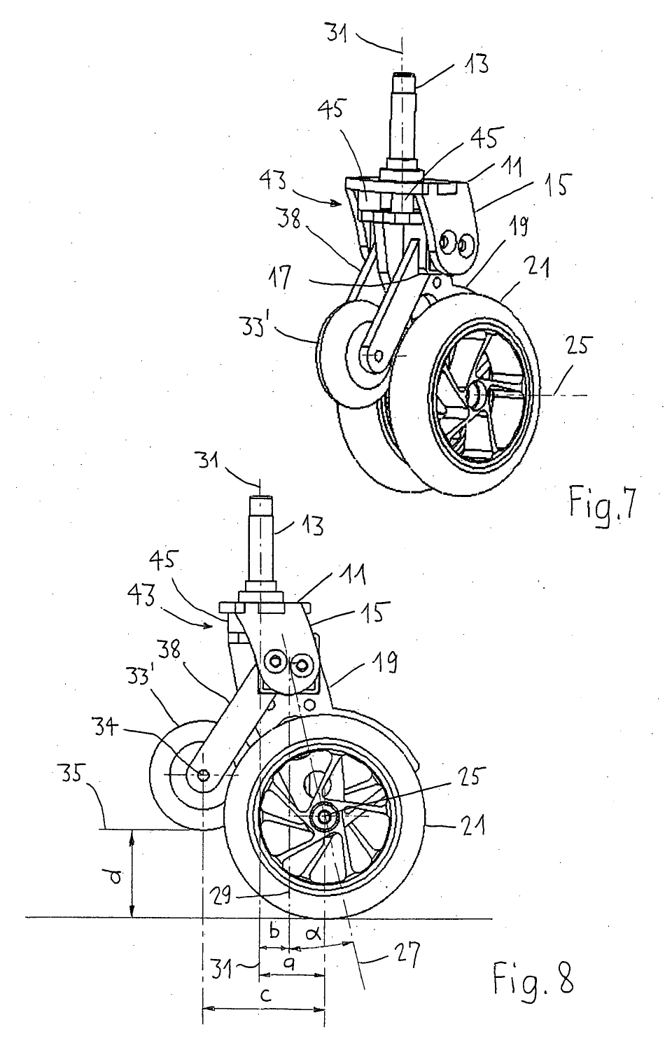

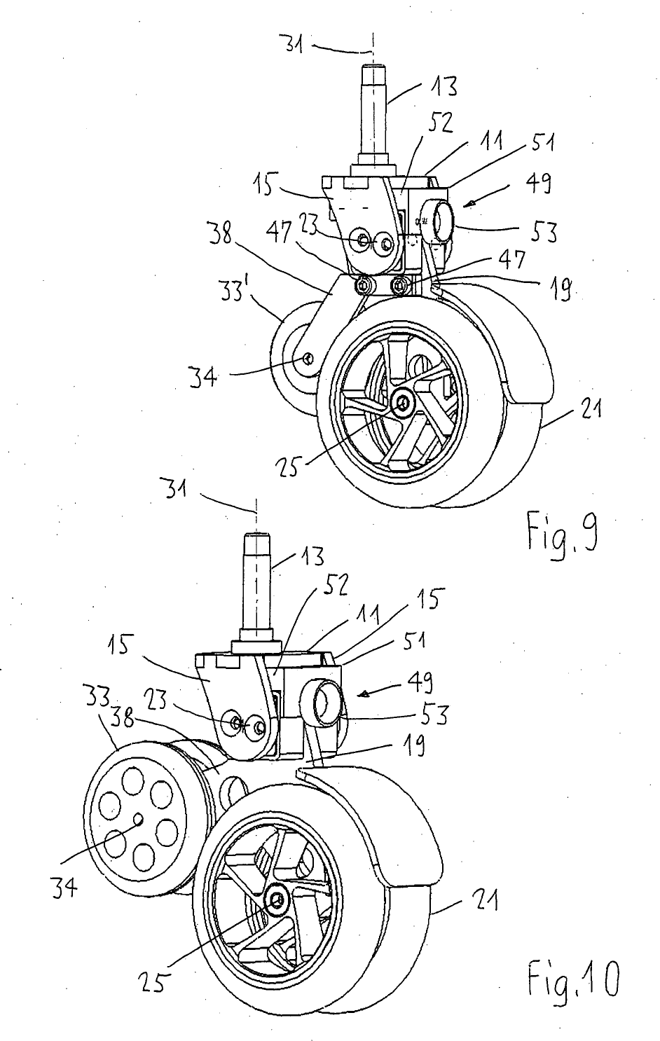

FIG. 4 a perspective view of a second embodiment example,

FIG. 5 a further view of the swivel wheel unit of FIG. 4,

FIG. 6a to 6h different phases on overcoming an obstacle

FIG. 7 a perspective view of a third embodiment example,

FIG. 8 a lateral view of the swivel wheel unit of FIG. 7,

FIG. 9 a perspective view of a swivel wheel unit as in FIGS. 7 and 8, but with an Adjustable—and removable lifting wheel, and with a blocking device,

FIG. 10 a perspective view of a swivel wheel unit with a lever pair and with a blocking device.

The first embodiment example of the swivel wheel unit shown in the FIGS. 1 and 2 has a support 11 on which a rotation bearing, for example a pin 13 is formed, which may rotate in a bearing of the vehicle, for example of a wheelchair, which is not shown. The support 11 has two arms 15. A joint, for example a spring joint 17 of the type “ROSTA” (™), is arranged between these. A pivot arm 19 is fastened on the spring joint 17, and a swivel wheel or a swivel wheel pair 21 is mounted at the free end of the pivot arm. The horizontal axis 23 of the spring joint 17 and the axis 25 of the swivel wheel pair 21 are located in a plane 27 (FIG. 2). The horizontal axis 23 is also located in a plane 29 (FIG. 2), which runs parallel to the vertical pivot axis 31 of the pin 13. In order for the swivel wheel or the swivel wheel pair 21 to be able to be easily pivoted, the axis 25 in the known manner must be arranged at a certain horizontal distance a) to the pivot axis 31 of the pin 13. Experience values for this are present from the state of the art. With the shown embodiment example, the angle alpha between the plane 27 and the plane 29 is about 15 degrees. This angle could however also be smaller or 0 degrees, if the spatial conditions permit the horizontal distance b) between the vertical axis 31 and the plane 29 to be dimensioned larger.

The use of a wheel pair 21 compared to the use of a single wheel has the advantage that it simplifies a turning. In particular, wheelchair users appreciate the fact that the force effort is lower when turning. The paired design is also advantageous when obliquely running up a small obstacle, for example a low kerb, since the wheel pair pivots on hitting an edge on the obstacle. The danger of the tire being lifted out, or of damage to the swivel wheel unit, are avoided by way of this.

The axis 34 of a lifting wheel or a lifting wheel pair wheel pair 33 is provided at a horizontal distance c) to the axis 25 of the swivel wheel or of the swivel wheel pair 33. The running plane 35 of the lifting wheel or of the lifting wheel pair 33 (FIG. 2) is arranged at a distance d) above the running plane 37 of the swivel wheel pair 21. The proportions between the distances a) to d) are advantageously roughly as is represented in the drawing. An arm 38 which is fastened on the spring joint 17 or is connected to the steering arm 19 serves the mounting of the lifting wheel or the lifting wheel pair 33. The arms 38 and 19 thus form an angle lever which, as the arrow 40 in FIG. 2 shows, may be pivoted about the axis 23 against the spring force of the spring joint 17. The possible extent of this pivoting is limited by an abutment which is not shown with this embodiment example.

On travelling over a relatively large obstacle, it is the lifting wheel or the lifting wheel pair 33 which first comes into contact with the obstacle. Here, the use of a wheel pair 33 when running up the obstacle in an oblique manner, has the same advantage as a swivel wheel on travelling over a small obstacle. If a wheel of the lifting wheel pair 33 hits an obstacle, then a pivoting about the pivot axis 31 is effected, so that both wheels of the lifting wheel pair 33 and later of the swivel wheel pair 21 simultaneously climb the obstacle, and the danger of a tire being lifted out, or of a damage to the swivel wheel unit is avoided.

The acting manner of the swivel wheel unit according to the FIGS. 1 and 2 is now described with reference to FIG. 3. Thereby, it may be assumed that here it is the case for example of the front wheel or the front wheels of a wheelchair, with which the user wishes to overcome the obstacle 41. Thereby, the following phases result:
a) the swivel wheel unit approaches the obstacle 41, for example a kerb,
b) the lifting wheel 33 makes contact with the obstacle 41,
c) the lifting wheel 33 climbs the obstacle 41 and lifts the front part of the wheelchair in height somewhat, so that the swivel wheel 21 loses contact with the ground 37. Forces arise with this, which tend to pivot the arm 38 about the axis 23 in the clockwise direction. The extent of the pivoting is however limited by an abutment which is not drawn in,
d) the swivel wheel 21 abuts on the obstacle 41,
e) the pivot arm 19 is pivoted, so that the swivel wheel 21 is lifted further. Simultaneously the axis 23 is pivoted about the point 42, thus the contact point of the lever arm 33 with the ground, which effects an additional lifting of the swivel wheel 21,
f) the pivot arm 19 is pivoted further together with the arm 38, so that the axis 25 of the swivel wheel 21 is located above the obstacle edge, and the swivel wheel 25 may therefore rotate,
g) the swivel wheel 21 travels up over the obstacle 41, and the lifting wheel 33 loses ground contact,
h) the swivel wheel 21 is now located on the obstacle 41, and the pivot arm 10 and the arm 38 pivot back into the initial position by way of the force of the spring joint 17.

After considering the overcoming of an obstacle, it is to be noted that the swivel wheel unit also has advantages on descending. Significant forces act on the swivel wheel unit on descending, so that the pivot arm 19 may be pivoted greatly upwards, and thus the front part of the vehicle moves downwards. This downwards movement however is stopped by way of the lifting wheel 33 making ground contact. There is no danger of the vehicle being able to tilt forwards about the axis 25 of the swivel wheel 21, in contrast to a commercially available swivel wheel.

The danger of a forward tilting about the axis 34 of the lifting wheel 33 is small, since this is located further to the front in the travel direction. The stability of the vehicle is thus increased due to the use of the described swivel wheel unit.

The second embodiment example of the swivel wheel unit shown in the FIGS. 4 and 5 differs from the previously described embodiment example essentially by way of the fact that the pivot arm 19 of the swivel wheel pair 21 is not connected to the spring joint 17 in a rigid, but in an articulated manner. For this purpose, a pin 13 is formed on the pivot arm 19 and is rotatable in a bearing 20 which is fastened on the spring joint 17. The result of this is that the swivel wheel 21 alone is deflected out with a curved journey, as is evident from FIG. 5, in contrast to the embodiment example according to FIGS. 1 and 2. However, as a comparison of FIGS. 3 and 6 shows, the manner of acting on overcoming an obstacle is the same in both cases, so that one may refer to the description of FIG. 3.

The embodiment example of the steering wheel unit shown in the FIGS. 7 and 8 differs from that embodiment shown in the FIGS. 1 to 3, above all by way of the fact that it is not a lifting wheel pair which is present, but only a single lifting wheel 33′, and that this lifting wheel 33′ engages into the intermediate space between the wheels of the steering wheel pair 21. This renders the steering wheel unit very compact, and simplifies the movement of the wheelchair or any other vehicle in restricted spaces. It has been found to be useful, to arrange the running plane 35 of the lifting wheel 33′ somewhat lower than with the use of a lifting wheel pair. The distance d) advantageously corresponds roughly to the radius of the steering wheel pair. By way of this, one ensures that the lifting wheel 33 makes ground contact at the right time on descending an obstacle, and thus the tilting danger is avoided, as this has already been described with reference to the FIGS. 1 and 2.

With this embodiment example, the abutment 43 which was not evident in the previous figures may be seen, and this for example consists of one or more blocks 45 of elastomer material. The comfort which the wheelchair provides may be increased by way of this, since the abutment 43 dampens the knock arising when the lifting wheel 33′ runs onto the obstacle 41 (FIG. 3b), and permits only a limited pivoting of the arm in the clockwise direction, in order to allow a lifting of the swivel wheel pair 21 (FIG. 3c).

The swivel wheel unit of FIG. 9 is designed in practically the same manner as that of FIG. 8, but however differs by way of the fact that the lifting wheel 33′ is arranged in an adjustable and removable manner. For this purpose, the arm 38 is fastened on the pivot arm 19 with screws 47. This for example permits a flexible use of the wheelchair. Thus the distance d (FIG. 8) may be adapted to the requirements of the user. Furthermore, the lifting wheel 33′ may be removed, for example should the wheelchair only be used indoors.

FIG. 9 furthermore shows the possibility of blocking the spring joint 17 with a blocking device 49, for example given sport with the wheelchair. The blocking device 49 consists of an angled piece 51, which engages with an arm 52 into the space between the support 11 and the spring joint 17, and is fastened with screw 523 which may be rotated by hand. It is however also possible to design the blocking device 49 in a different manner, for example such that it forms an adjustable abutment and only effects a blocking in an end position.

FIG. 10 shows a swivel wheel unit as in FIG. 9. The arm 38 however may not be removed, and a wheel pair 33 is provided as a lifting wheel.

Various further changes are possible without deviating from the basic concept of the invention. Thus for example, as in the state of the art, one may arrange the swivel wheel and the lifting wheel in a laterally offset manner, so that seen from the side, they overlap. One may also just as well use two or more lifting wheels. It would also be conceivable to ultilise forces, different to the force of spring means.

Summarising, one may deduce the following:

The swivel wheel unit has a support 11 with a vertical pin 13 which is mounted in a bearing of the wheelchair or of another apparatus, in order, when travelling curves or on turning, to permit a pivoting of the pivot arm 19, at whose end the swivel wheel 21 is rotatably mounted. A joint 17 also permits a movement about the horizontal axis 23 against the force of spring means when the swivel wheel 21 hits an obstacle 41. The joint 17 is a spring joint and, as long as no obstacle 41 occurs, holds the pivot arm 19 in the shown normal position. A lifting wheel 33 which firstly lifts the swivel wheel 21 for overcoming an obstacle, is located in front of the swivel wheel 12, but in a raised manner, wherein when the swivel wheel 21 hits the obstacle 41, the pivot arm 19 is pivoted and the swivel wheel 21 is lifted further. Since the arm 38 of the lifting wheel 33 is also co-pivoted, the horizontal axis 23 is also lifted by way of this, which effects an additional lifting of the swivel wheel 21. The swivel wheel 21 may climb the obstacle 41 as soon as the axis 25 of the swivel wheel 21 comes to lie higher that the obstacle 41.

1. A swivel wheel unit, comprising:
a first arm which may be freely pivoted horizontally about a vertical pivot axis, and on which a swivel wheel is arranged, whose axis is located at a horizontal distance to a vertical pivot axis; and
a lifting wheel is arranged in front of the swivel wheel on a second arm, the swivel wheel together with the lifting wheel may be pivoted about a horizontal axis against the force of a spring means.

2. A swivel wheel unit according to claim 1, wherein the horizontal axis is arranged at a location, which in the vertical, is located above, and in the horizontal, below the axes of the lifting wheel and of the swivel wheel.

3. A swivel wheel unit according to claim 1, wherein the spring comprises a spring joint, and that the horizontal axis is formed by the axis of the spring joint.

4. A swivel wheel unit according to claim 3, wherein a support for the spring joint is provided, which comprises two arms, between which the spring joint is arranged.

5. A swivel wheel unit according to claim 1, wherein the horizontal axis is arranged at a distance behind the vertical axis.

6. A swivel wheel unit according to claim 1, wherein the plane in which the horizontal axis and the axis of the swivel wheel are located, is arranged at an angle of 0 to 30 degrees, to the vertical pivot axis.

7. A swivel wheel unit according to claim 1, wherein the support comprises a rotation bearing which fits into a bearing of a traveling object, in order to permit a pivoting of the swivel wheel about the pivot axis.

8. A swivel wheel unit according to claim 3, wherein the first arm with the swivel wheel is pivotably mounted in a bearing arranged on the spring joint, about the pivot axis.

9. A swivel wheel unit according to claim 1, wherein an abutment (43), for example a block (45) of elastomeric material, is provided, which in operation limits the extent of the pivoting about the mentioned horizontal axis (23) in the one and/or the other direction.

10. A swivel wheel unit according to claim 1, wherein the distance (d) between the running plane (35) of the lifting wheel (33), and the running plane (35) of the swivel wheel (21) is equally large or somewhat larger than the radius of the swivel wheel (21).

11. A swivel wheel unit according to claim 1, wherein the swivel wheel comprises a swivel wheel pair, the lifting wheel comprises a lifting wheel pair.

12. A swivel wheel unit according to claim 1, wherein the second arm with the lifting wheel is arranged in at least one of a removable or adjustable manner.

13. A swivel wheel unit according to claim 1, wherein a blocking device is provided for blocking the pivoting of the first arm.

14. The swivel wheel unit according to claim 1, further comprising a motor-driven wheelchair, with at least one swivel wheel comprising at least one of a front wheel or a rear wheel of the motor-driven wheelchair.
